(19) United States
(12) Patent Application Publication
(10) Pub. No.: US 2012/0239887 A1
(43) Pub. Date: Sep. 20, 2012

(54) METHOD AND APPARATUS FOR MEMORY CONTROL

(75) Inventors: James R. MAGRO, Austin, TX (US); Shwetal A. PATEL, San Jose, CA (US)

(73) Assignee: ADVANCED MICRO DEVICES, INC., Sunnyvale, CA (US)

(21) Appl. No.: 13/049,670

(22) Filed: Mar. 16, 2011

(51) Int. Cl. G06F 12/00

(52) U.S. Cl. 711/154; 711/E12.001

(57) ABSTRACT

A method is provided for issuing subcommands to a memory module using unassigned bits in a memory control protocol. A buffer component within the memory module receives the subcommands and modifies a state of the memory module accordingly. This allows, for example, selectively powering down individual ranks of the memory module (e.g., an LRDIMM memory module). Unassigned bits in a JEDEC-compliant ZQ calibration command set may be used for implementing such subcommands.

### FIELD OF THE INVENTION

The present invention generally relates to memory devices, and more particularly relates to the control of memory modules.

### BACKGROUND OF THE INVENTION

Modern electronic devices, particularly general purpose computers, often include one or more memory modules, such as single in-line memory modules (SIMMs) or dual in-line memory modules (DIMMs), each of which might include one or more synchronous dynamic random access memories (SDRAMs) or other forms of RAM. Modern memory modules, particularly SDRAMs, may be partitioned (logically and/or physically) into one or more individual “ranks” of memory, i.e., a blocks or areas of data that are created using some or all the individual memory integrated circuits (ICs) within a memory module.

SDRAMs are almost universally manufactured in compliance with one or more standards promulgated by JEDEC (the Joint Electron Devices Engineering Council). Similarly, the various methods and protocols for communicating with such memory devices are also specified by JEDEC. While these protocols allow for adequate control of modern memory modules, certain aspects of the JEDEC control scheme can be unsatisfactory.

For example, because the individual memory control commands and functions are specified by JEDEC, it is typically not possible to issue custom commands or subcommands to a memory module while still adhering to the JEDEC specifications.

### BRIEF SUMMARY OF EMBODIMENTS OF THE INVENTION

In accordance one embodiment, a method is provided for issuing a subcommand to a memory module configured to communicate in accordance with a memory communication protocol having a plurality of predefined commands. The method includes selecting, from the plurality of predefined commands, a predefined command that includes one or more undefined bits; encoding the subcommand within the selected predefined command using the undefined bits; and transmitting the selected predefined command to the memory module to modify a state of the memory module.

A method in accordance with another embodiment includes selecting a set of commands from a memory communication protocol configured to control the memory module, each of the set of commands having at least one undefined bit; associating the at least one undefined bit with at least one subcommand; and controlling the memory module using the at least one subcommand.

A memory control system in accordance with one embodiment includes a memory controller and a memory module configured to communicate with the memory controller in accordance with a memory communication protocol having a plurality of predefined commands. At least one of the predefined commands includes one or more unassigned bits. A buffer within the memory module is configured to receive a subcommand (using the one or more unassigned bits) from the memory controller and to control a state of the memory module.

### BRIEF DESCRIPTION OF THE DRAWINGS

The present invention will hereinafter be described in conjunction with the following drawing figures, wherein like numerals denote like elements, and wherein:

FIG. 1 is a conceptual block diagram of a conventional memory control system;

FIG. 2 is a conceptual block diagram of a memory control system in accordance with one embodiment of the invention; and

FIG. 3 is a table depicting undefined bits in a command relating to a particular embodiment of the present invention.

### DETAILED DESCRIPTION

In general, embodiments of the present invention relate to systems and methods for selectively powering down individual ranks of a memory module (e.g., an LRDIMM memory module) using undefined bits in a memory control protocol. In a particular embodiment, for example, unused bits in a JEDEC-compliant ZQ calibration command set are utilized for this purpose.

For simplicity and clarity of illustration, the drawing figures depict the general structure and/or manner of construction of various embodiments. Elements in the drawings figures are not necessarily drawn to scale: the dimensions of some features may be exaggerated relative to other elements to assist understanding of the exemplary embodiments. In the interest of conciseness, conventional techniques, structures, and principles known by those skilled in the art may not be described herein, including, for example, standard semiconductor processing techniques, fundamental principles of microprocessors, and basic operational principles of memory devices.

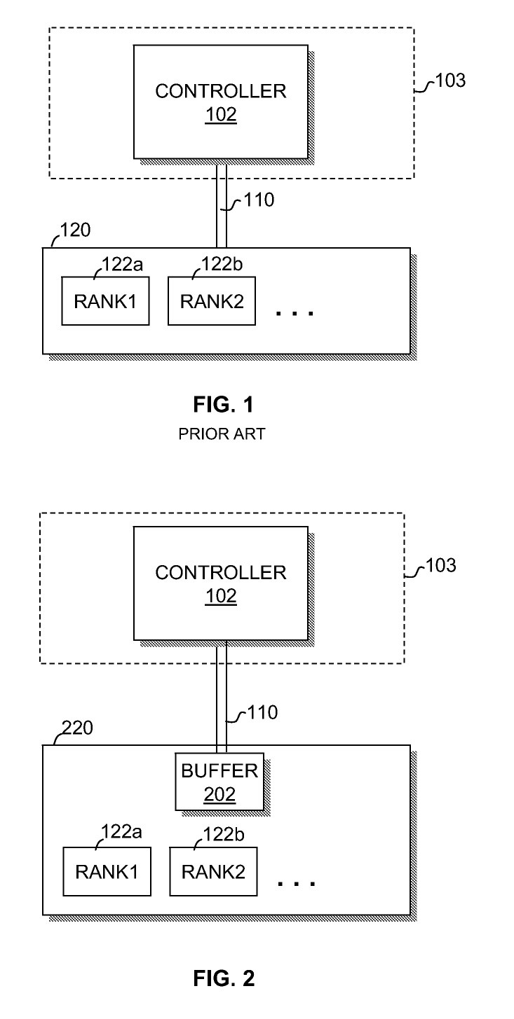

Referring to the conceptual block diagram shown in FIG. 1, conventional memory control schemes include a controller 102 (e.g., a DRAM controller) communicatively coupled to a memory module 220 (e.g., a DIMM module comprising one or more SDRAMs) via a bus 110 (e.g., a DDR bus). Controller 102 will typically be a subcomponent of another electronic device 103 (a processor, a system-on-chip (SOC), or the like). Memory module 220 may include one or more individual “ranks” of memory 122 (e.g., 122a and 122b). A rank, as mentioned above, is a block or area of data that is created using some or all the individual memory ICs within a memory module 220. These ranks may be physical and/or logical ranks Single-side modules (SIMMs) typically have one or two ranks, while double-sided modules (DIMMs) commonly have either a single rank, two ranks, or four ranks In one embodiment, according to various JEDEC standards, a rank is 64 bits wide. Embodiments of the present invention contemplate memory modules 220 having any number of ranks with any suitable width. Load-reduced DIMMs (LRDIMMs) include a buffer configured to reduce the data load. In this way, the user may add more DIMMs per channel and increase memory capacity and speed.

In accordance with one embodiment, controller 102 is configured to communicate with memory module 220 in accordance with a communication standard, e.g., a JEDEC standard. In one embodiment, a portion of the communication between controller 102 and memory module 220 is specified by “LRDIMM Specification: Memory Buffer (MB) JEDEC JESD82-XX” (v0.9 Draft, September 2010). For ease of reference, this standard and related family of standards may be referred to collectively herein as the “JEDEC standard.”

As stated above, it would be desirable to power down one or more individual ranks 122 of memory module 220—e.g., power down rank 1 (122a) without powering down rank 2 (122b). Conventional memory control methods typically only allow power down of all ranks at the same time, and more generally do not allow custom commands to be sent to memory module 220.

In accordance with various embodiments of the invention, and as described in further detail below, unallocated bits (e.g., undefined address bits) associated with a command within the existing communication standard are used to issue such a subcommand. The term “subcommand” is used in the general sense as a command that is “hidden,” encoded, or otherwise included within a pre-existing, predefined command.

Referring to FIG. 2, an embodiment of the present invention includes a buffer 202 within memory module 220 that is communicatively coupled to controller 102 via bus 110. Buffer 202 generally receives commands and/or subcommands from controller 102 and manipulates a state of memory module 220 in accordance with those commands and/or subcommands (e.g., selectively powering down one or more ranks 122). Buffer 202 may also include control logic (not shown) configured to manipulate the state of memory module 220. Other commands may be sent directly through buffer 202 (to module 220) without being modified (pass-through).

More particularly, in the context of modern DIMMs, it is desirable to send calibration commands to individual SDRAMs within module 220 to account for variations in the system environment (e.g., temperature, voltage, and/or component drift.) In the JEDEC standard referenced above, for example, what is termed a “ZQ calibration command” is issued for this purpose. The ZQ calibration command is used to calibrate the output drivers and other values associated with memory module 220. It is often used during power-up initialization and reset, though subsequent commands can be issued while portions of module 220 are idle.

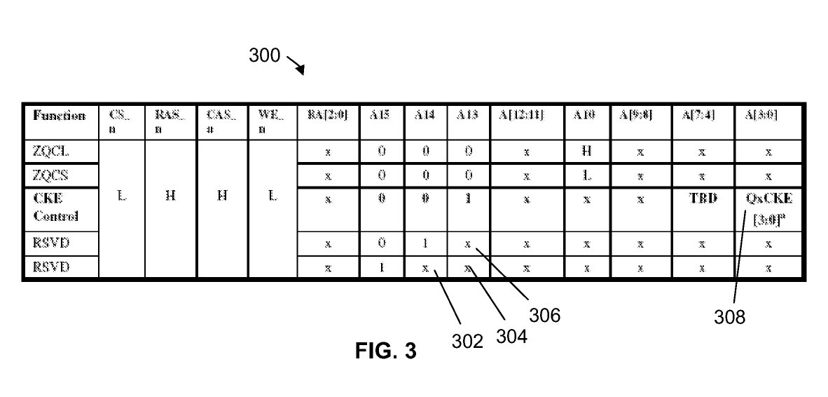

FIG. 3 presents a table 300 illustrating the various bits of the ZQ calibration command (which in the JEDEC specification is labeled as the “Soft CKE” command definition). From right to left, columns A[3:0] to A[15] specify the content of a 16-bit command to be sent to memory module 220. “H” refers to a “high” value (e.g., logical 1), and “L” refers to a “low” value (e.g., a logical 0). An “x” in any given column refers to an undefined bit. Each row in FIG. 3 corresponds to a separate function. “ZQCL” refers to a ZQ Calibration Long function, ZQCS refers to ZQ Calibration Short function, “CKE Control” refers to a clock control function, and “RSVD” refers to “reserved” function. A person of ordinary skill in the art will understand the purpose and nature of each of these functions and commands in light of the JEDEC standard, and are therefore not described in detail herein.

Any of the various bits labeled as “x” may be used by buffer 202 to issue subcommands to memory module 220. In a particular embodiment, one or more bits within A[15:13] (including, for example, those at positions 302, 304, and 306 in table 300) are used in an encoded fashion to provide eight possible subcommands.

In a particular embodiment, one or more unallocated bits within A[15:13], such as bits at position 302, 304, and 306, are used in connection with other bits within table 300 (e.g., the QxCKE bits 308) to specify that a particular rank 122 within memory module 220 should be selectively powered down. For example, bits A[15:13] may be used to encode a command such as A[15:13]=001 to represent the CKE control command. When that code is subsequently decoded, then A[3:0], the QxCKE field bits 308, are used to specify the state of the CKE pins such that CKE pin=0 equates to a rank in power down, and CKE=1 corresponds to a rank not in power down. Thus, if A[3:0]=0110 (where the least-significant bit is on the right), then buffer CKE pin 0 would be driven LOW (in power down), CKE pin 1 would be driven HIGH (not in power down), CKE pin 2 would be driven HIGH (not in power down), and CKE pin 3 would be driven LOW (in power down).

In alternate embodiments, undefined bits illustrated in FIG. 3 are used for other subcommands, e.g., other “in-band” commands such as commands to lower the voltage to particular DDR devices, or commands to initiate a buffer feature that is specific to a particular buffer vendor associated with buffer 202.

In general, then a method in accordance with the present invention includes selecting a set of commands that have at least one undefined bit (which may result in a set of bits spread across multiple commands), and then associating one or more subcommands with one or more of those bits.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A method for issuing a subcommand to a memory module configured to communicate in accordance with a memory communication protocol having a plurality of predefined commands, comprising:
selecting, from the plurality of predefined commands, a predefined command that includes one or more undefined bits;
encoding the subcommand within the selected predefined command using the undefined bits; and
providing the selected predefined command for transmission to the memory module.

2. The method of claim 1, wherein the subcommand comprises an instruction to power down a selected memory rank within the memory module and not power down a non-selected memory rank within the memory module.

3. The method of claim 2, wherein the memory communication protocol is a JEDEC standard.

4. The method of claim 3, wherein the selected predefined command is a ZQ calibration command.

5. The method of claim 4, wherein a plurality of QxCKE bits associated with the ZQ calibration command specify the selected memory rank to power down.

6. The method of claim 1, further including modifying a state of the memory module in accordance with the subcommand.

7. The method of claim 6, further including:
providing a buffer within the memory module;
transmitting the subcommand to the buffer; and
modifying the state of the memory module via the buffer.

8. A method of controlling a memory module, comprising:
selecting a set of one or more commands from a memory communication protocol configured to control the memory module, each of the set of one or more commands having at least one undefined bit;
associating the at least one undefined bit with at least one subcommand;
in response to receiving a command from the set of one or more commands, controlling the memory module based on the at least one subcommand of the received command.

9. The method of claim 8, wherein the memory communication protocol is a JEDEC standard, and controlling the memory module includes powering down a selected rank of the memory module in response to the at least one subcommand.

10. The method of claim 9, wherein the set of commands includes a ZQ calibration command.

11. The method of claim 10, wherein a plurality of QxCKE bits associated with the ZQ calibration command specify the selected rank.

12. The method of claim 8, further including:
providing a buffer within the memory module;
transmitting the at least one subcommand to the buffer; and
controlling the memory module via the buffer.

13. An electronic device comprising:
a memory module configured to communicate with a memory controller in accordance with a memory communication protocol having a plurality of predefined commands, at least one of the predefined commands including one or more unassigned bits; and
wherein the memory module includes a buffer communicatively coupled to the memory controller, the buffer configured to receive a subcommand from the memory controller using the one or more of the unassigned bits, and to modify a state of the memory module in accordance with the subcommand.

14. The memory control system of claim 13, wherein the memory module has a plurality of memory ranks, and wherein the subcommand is adapted to instruct the buffer to power down a selected one of the plurality of memory ranks

15. The memory control system of claim 14, wherein the memory communication protocol is a JEDEC standard, and the one or more unassigned bits are provided within a ZQ calibration command specified by the JEDEC standard.

16. The memory control system of claim 15, wherein a plurality of QxCKE bits associated with the ZQ calibration command determine the selected one of the plurality of memory ranks to power down.

17. The memory control system of claim 13, wherein the memory module is a load-reduced dual in-line memory module (LRDIMM).

18. The memory control system of claim 13, wherein the subcommand is configured to instruct the buffer to reduce a voltage of a component within the memory module.

19. The memory control system of claim 13, wherein the subcommand is configured to instruct the buffer to initiate a feature of the buffer.

20. The memory control system of claim 19, wherein the feature of the buffer is a vendor-specific feature of the buffer.
